(19) United States
(12) Patent Application Publication
(10) Pub. No.: US 2004/0225390 A1
(43) Pub. Date: Nov. 11, 2004

(54) Direct methods system for assembly of products

(75) Inventors: Daniel A. Keller, Wichita, KS (US); Justin B. Mortensen, Wichita, KS (US); James D. Pate, Derby, KS (US)

Correspondence Address: LSI LOGIC CORPORATION, 1621 BARBER LANE, MS: D-106 LEGAL, MILPITAS, CA, 95035, US

(73) Assignee: LSI LOGIC CORPORATION

(21) Appl. No.: 10/151,403

(22) Filed: May 20, 2002

(51) Int. Cl. G06F 19/00

(52) U.S. Cl. 700/95

(57) ABSTRACT

A method for product assembly control comprising the steps of assembling the product in response to one or more assembly steps, tracking completion of the assembly steps, where a next one of the assembly steps is not started until each prior one of the assembly steps is completed, and tracking components consumed while performing the assembly steps.

### FIELD OF THE INVENTION

The present invention relates to a method and/or architecture for product assembly generally and, more particularly, to a direct methods system for product assembly.

### BACKGROUND OF THE INVENTION

Referring to FIG. 1, a flow diagram 10 of a conventional method (or process) for product assembly is shown. A product assembly job includes an assembly work order generated from a manufacturing database. The process 10 includes steps 12, 14, 16, 18, 20 and 22. During the step 12 an operator logs on to the manufacturing methods system at a workstation by typing in their user ID and password. The operator retrieves an assembly number that corresponds to the job from the unit (i.e., product) paperwork.

The process 10 continues to the step 14 and the operator views a product selection screen 30 (shown in FIG. 2) and selects an assembly line from product assembly lines 32a-32n. However, since the step 14 is a determination performed by the operator, an incorrect assembly line 32 can be selected. When an incorrect assembly line 32 is selected, time is wasted and the product can be incorrectly assembled.

The method 10 continues to the step 16 and the operator selects a methods document from a document selection screen 40 (shown in FIG. 3). The document selection screen 40 includes a list of all documents 42a-42n related to the selected assembly line 32. However, since the determination of the methods document 42 is performed by the operator, when an incorrect methods document 42 is selected, time is wasted and the product can be incorrectly assembled. The method 10 continues to the step 18.

During the step 18, the operator scrolls through the methods document 42 to access the instructions for assembling the product. The methods document 42 includes a bill of materials (BOM), numbered assembly steps, figures, and tables for product configuration specific data. However, the methods document BOM has been entered into the methods document 42 and is not directly tied to the BOM in the job. The operator compares the methods document 42 BOM with the unit paperwork BOM. When the BOMs do not match, time is wasted and the product can be incorrectly assembled. The process 10 continues to the step 20.

During the step 20 the operator matches part numbers on the unit paperwork with part numbers in the methods configuration table 50 (shown in FIG. 4) to obtain configuration specific data. When the part numbers on the unit paperwork fail to match part numbers in the methods table 50, time is wasted and the product can be incorrectly assembled. The method 10 continues to the step 22. During the step 22, the operator completes their portion of the product assembly process 10 and the unit that is being assembled is sent to the next assembly workstation.

To update drawings and part numbers in the conventional process 10, a manufacturing engineer and/or technician checks and changes all the parts in the drawings and the corresponding part numbers in the method steps. No report of the changes is available. The manufacturing engineer and/or technician will write an assembly method in PDF format that is static (i.e., not dynamically updated). The conventional process 10 does not support dynamic updates. To view the updates, a user logs on the system to view the new drawings, part numbers, assembly steps, etc. The manufacturing engineer and/or technician provides coordination of the updates with planners, buyers and supervisors.

Methods update postings in the conventional process 10 are performed on a workstation by workstation basis. The process 10 does not support simultaneous workstation posting. The process 10 does not support step-by-step parts inventory consumption tracking. As a result of the step-by-step updates and coordination performed by the manufacturing engineer and/or technician, timing is critical. Conventional approaches can consume excessive levels of resources and provide a limited level of manufacturing process control and accuracy.

It would be desirable to have a method and/or architecture for a direct methods system of product assembly that provides easily developed and maintained assembly methods via a complete information tracking and control system.

### SUMMARY OF THE INVENTION

The present invention concerns a method for product assembly control comprising the steps of assembling the product in response to one or more assembly steps, tracking completion of the assembly steps, where a next one of the assembly steps is not started until each prior one of the assembly steps is completed, and tracking components consumed while performing the assembly steps.

The objects, features and advantages of the present invention include providing a direct methods system for product assembly that may (i) provide easily developed and maintained assembly methods via a complete information tracking and control system, (ii) display the appropriate methods at the appropriate time directly from one or more linked databases and/or tables within the databases, (iii) correlate assembly workstation identification and specific product data, (iv) implement rich multimedia content to provide an operator with an interactive experience, (v) dynamically retrieve image and video content in real time when methods (or method steps) are displayed, (vi) implement computer aided drawing (CAD) animation, live video, etc. to provide visual assembly aid to the operator, (vii) implement application programming interfaces (API) such that drawing images, annotations, notes from drawings, etc. may be programmatically extracted (retrieved), (viii) track and record parts consumed from inventory, (ix) support one or more engineering change order (ECO) process launches via a direct methods approval process, (x) provide security analogous to database programs, (xi) provide a security clearance process such that a user having limited security clearance may perform part of the methods and/or ECO and another user having additional security clearance may approve and submit a completed version of the methods and/or ECO, (xii) generate a report that may detail methods related files that may be updated when an ECO is implemented, (xiii) generate a “to do” list of changes and directly launch the applications where the changes may be implemented, (xiv) update and/or record superseded methods revision level fields during the database and/or table revision process, (xv) record and store the superseded methods, (xvi) generate reports including workstation screen graphics (e.g., graphical user interfaces, configuration tables, etc.), (xvii) integrate well with manufacturing management information systems (MMIS), factory automation systems (FAS), Win32® (or other software) application programming interfaces (API), and/or application deployment and solution display software runtime server components, (xviii) be implemented as a runtime object, (xix) provide an editor configured to provide rapid, real time generation and maintenance of the system, (xx) provide operator level implementations, (xxi) implement workstation graphics that may directly correspond to operations, sub-assemblies, components, etc. (e.g., in a “what you see is what you get” (WYSIWYG) format from a perspective of the operator), (xxii) provide a viewer application (or operation, routine, etc.) configured as a single interface for users (e.g., assembly operators, engineers, technicians, etc.), (xxiii) provide a flexible manufacturing model, (xxiv) provide one or more simulators and mirrored test databases and/or tables that provide for operations, updates, changes, etc. to be performed and tested off-line and implemented to production at a scheduled time, (xxv) provide the test database for training and/or for situations where the methods may be viewed offline, (xxvi) link operators to specific products and product quality data, (xxvii) provide a direct link between assembly errors and the operator committing the errors, (xxviii) indicate the operators that may be considered for additional training and the type of training to be conducted, (xxix) link workstations to specific products and product quality data, (xxx) indicate workstations that may be considered for reconfiguration and/or repair and the type of repair to be implemented, (xxxi) provide manufacturing engineers with more time to focus on engineering tasks and process improvements, (xxxii) implement programmatic methods generation that may be applied to other assembly methods and/or projects in addition to assembly methods (e.g., be scalable to other projects), (xxxiii) enhance manufacturing engineering processes, and/or (xxxiv) support quality and production time improvement initiatives.

### BRIEF DESCRIPTION OF THE DRAWINGS

These and other objects, features and advantages of the present invention will be apparent from the following detailed description and the appended claims and drawings in which:

FIG. 1 is a flow diagram of a conventional product assembly method;

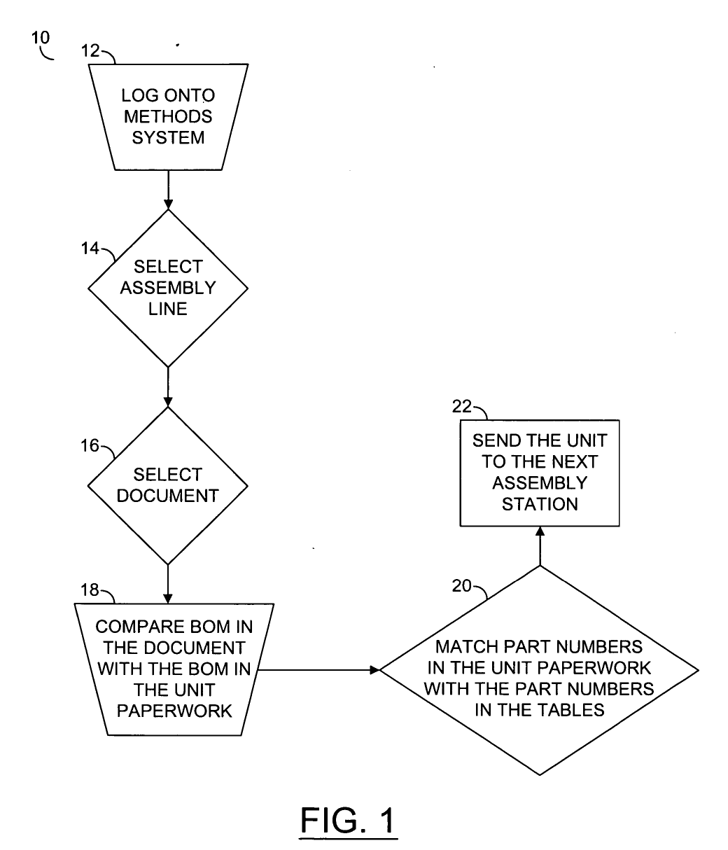

FIG. 2 is a diagram of a conventional product selection screen;

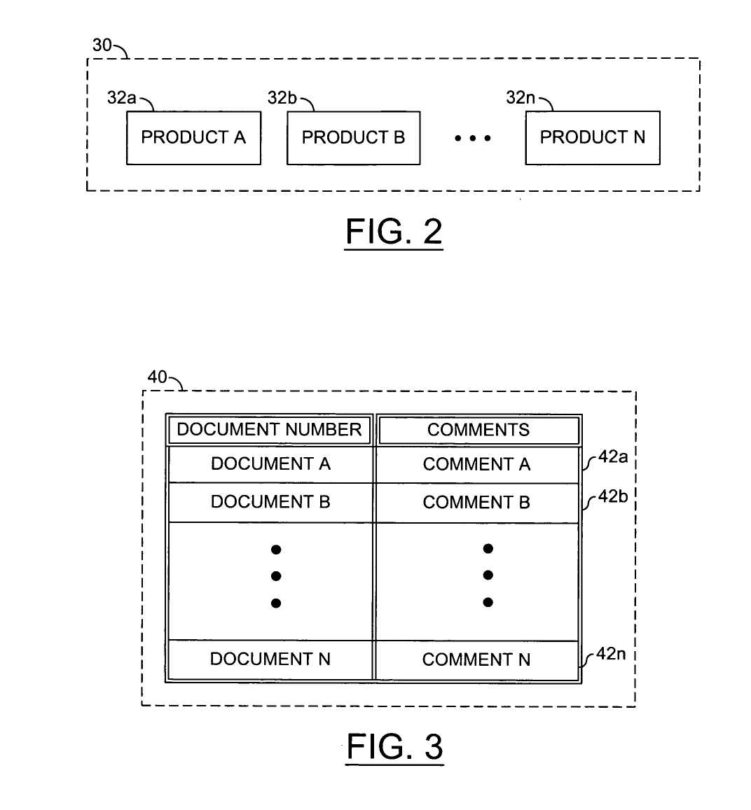

FIG. 3 is a diagram of a conventional document selection screen;

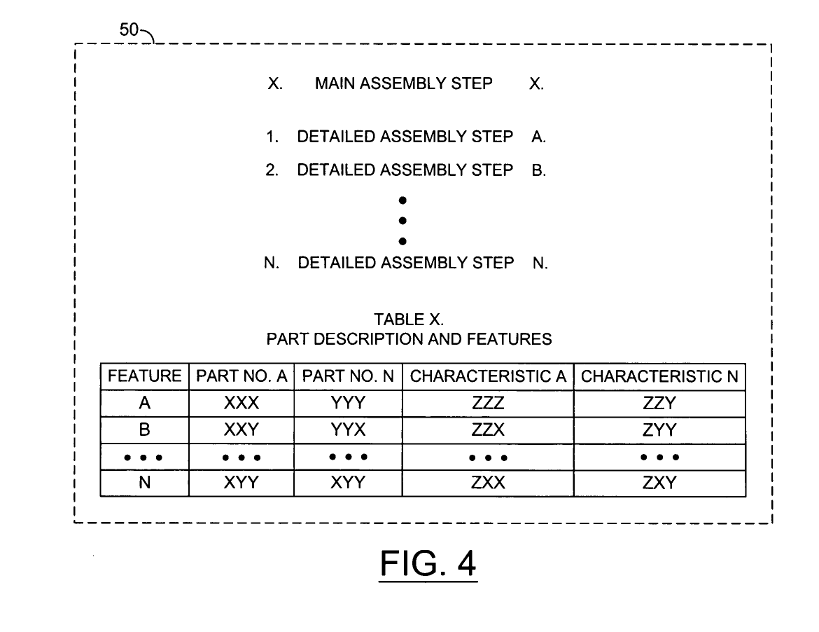

FIG. 4 is a diagram of a conventional configuration table;

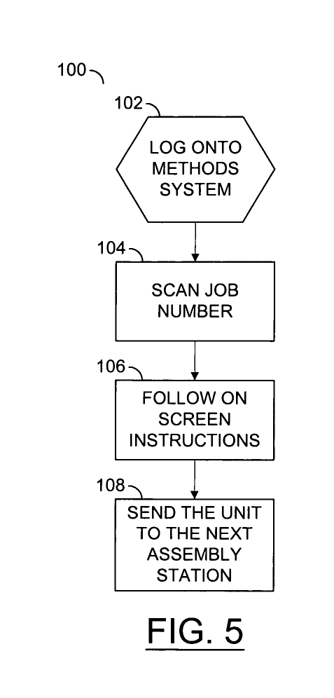

FIG. 5 is a flow diagram illustrating a preferred embodiment of the present invention;

FIG. 6 is a diagram of a database interfacing of the present invention;

FIGS. 7(a-b) are diagrams of example databases of the present invention;

FIG. 8 is a diagram of a screen image of the present invention;

FIG. 9 is a diagram of another screen image of the present invention;

FIG. 10 is a diagram of another screen image of the present invention;

FIG. 11 is a diagram of another screen image of the present invention; and

FIG. 12 is a diagram of another screen image of the present invention.

### DETAILED DESCRIPTION OF THE PREFERRED EMBODIMENTS

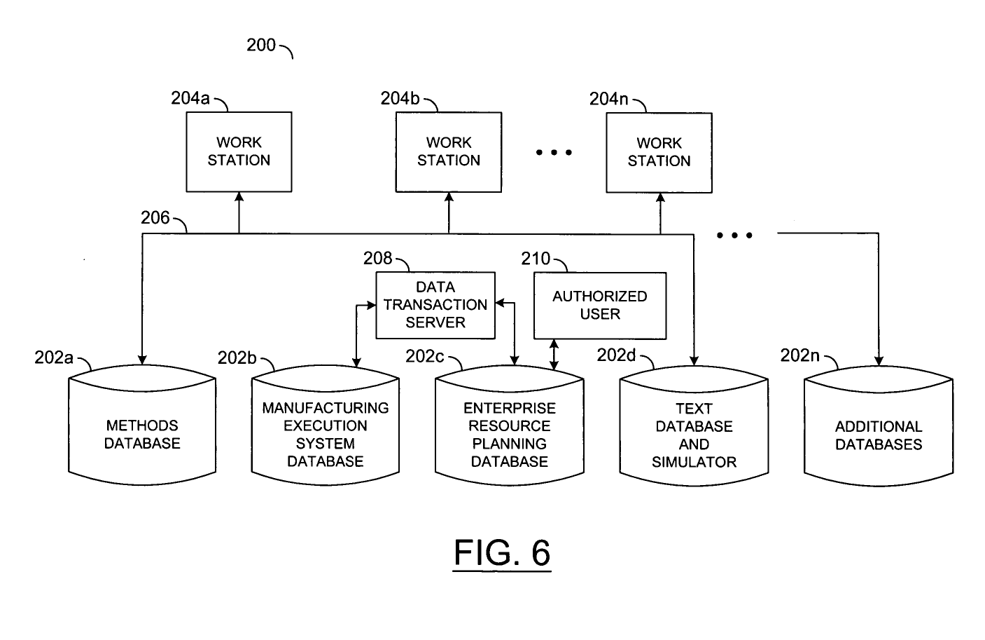

Referring to FIG. 5, a flow diagram 100 illustrating a method (or system, process, routine, operation, etc.) in accordance with a preferred embodiment of the present invention is shown. The method 100 may be implemented as a product (or unit) assembly method and/or architecture. The method 100 may be implemented as a direct methods system and/or architecture for assembly of products. In one example, the method 100 may be implemented as a direct methods system and/or architecture for assembly of data storage products. The process 100 may be particularly suited to custom (e.g., non-standard production) product manufacturing applications. The system 100 may provide a viewer application (or operation, routine, etc.) configured as a single interface for users (e.g., assembly operators, designers, engineers, technicians, etc.). However, the process 100 may be implemented for any appropriate product assembly to meet the design criteria of a particular application.

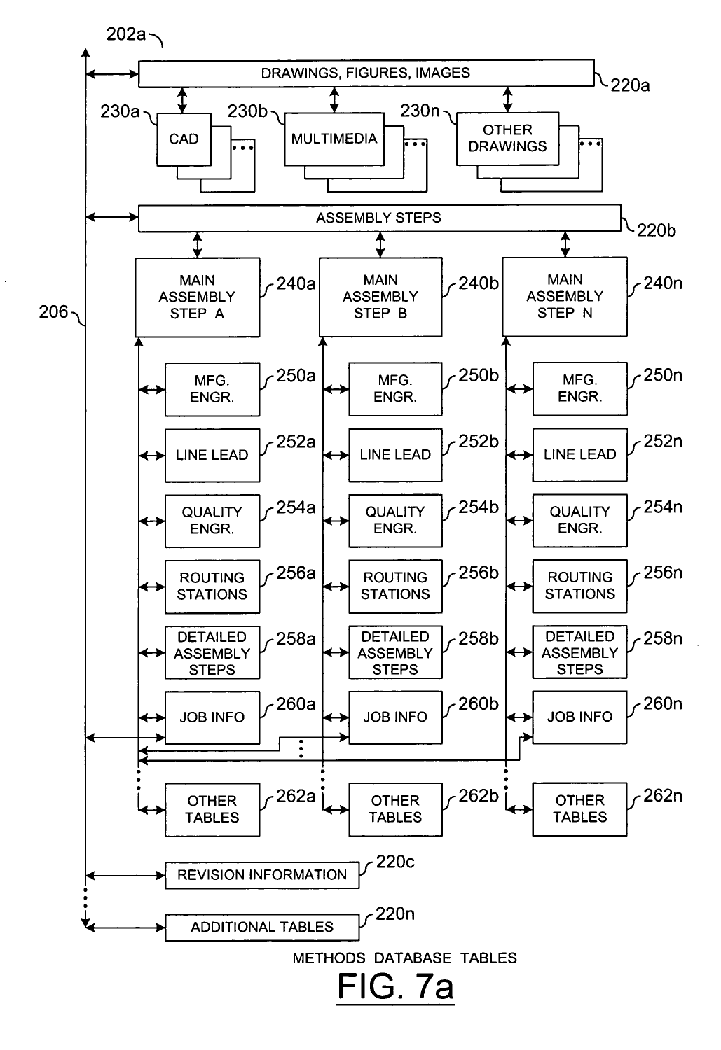

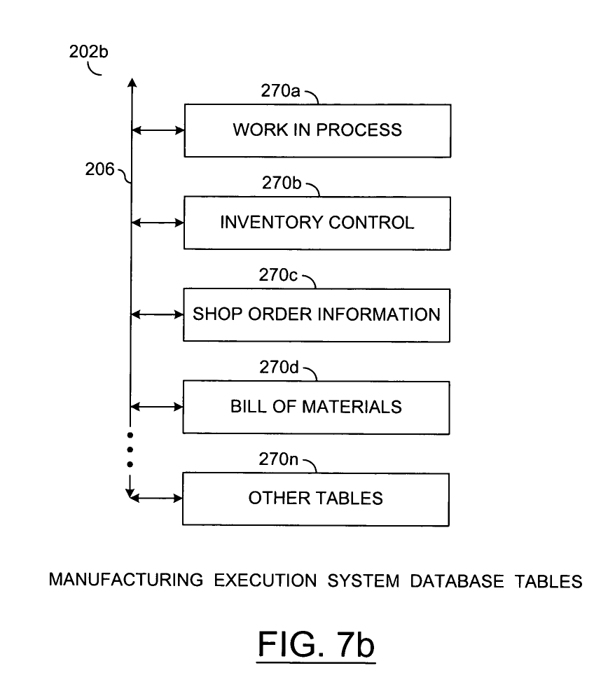

The process 100 generally corresponds to a job (e.g, a particular product or number of products to be manufactured) that comprises an assembly work order that is generally generated from one or more enterprise resource planning (ERP) systems. ERP systems generally comprise computerized methods for planning the integration and implementation of resources, generally in a manufacturing environment. ERP systems implemented in connection with the process 100 may be configured to link (interface) a number of resource databases and/or tables (described in connection with FIGS. 6 and 7(a-b)). The job generally comprises a bill of materials (BOM) and/or one or more assembly steps (methods, operations, blocks, routines, tasks, etc.) to be performed by a manufacturing assembly operator.

Referring to FIG. 6, a diagram illustrating a system 200 in accordance with the system 100 of the present invention is shown. The system 200 may be implemented as a number of linked (interfaced) databases (and/or tables within the databases) that are accessed from a number of workstations, servers, etc. The system 200 generally comprises one or more databases 202 (e.g., 202a-202n), a number of workstations 204 (e.g., 204a-204n), a bus 206, a server 208, and one or more authorized user terminals 210. The database 202a may be implemented as a methods database (described in more detail in connection with FIG. 7a). The database 202b may be implemented as a manufacturing execution system database (described in more detail in connection with FIG. 7b). The database 202c may be implemented as an ERP database. The database 202d may be implemented as a test database and simulator. The system 200 may be implemented having one or more appropriate additional databases (e.g., databases 202(d+1)−202n) to meet the design criteria of a particular application. The additional databases 202 may be implemented as one or more employee databases, quality databases, etc.

The workstations 204 may be implemented as manufacturing workstations where the products (units) that are assembled (manufactured) in accordance with the present invention are manufactured (and/or tested, inspected, etc.). Each of the workstations 204a-204n generally corresponds to one or more assembly direct methods.

The bus 206 may be implemented as one or more system busses configured to interface the databases 202 to each other and/or to the workstations 204. One or more portions of the bus 206 may be implemented to interface the server 208 between the database 202b and the database 202c. One or more portions of the bus 206 may be implemented to interface one or more terminals 210 to the database 202c.

The server 208 may be implemented as a data transaction server. The server 208 may be configured as a dedicated server that is implemented to provide interfacing between the manufacturing execution system database 202b and the ERP database 202c. The one or more authorized user terminals 210 (one shown) may be implemented to provide users having a particular authorization (e.g., specifically authorized employees) access to the ERP database 202c.

Referring to FIG. 7a, a diagram illustrating the methods database 202a is shown in accordance with a preferred embodiment of the present invention. The database 202a generally comprises one or more tables (directories, files, etc.) 220 (e.g., tables 220a-220n). The table 220a may be implemented as an images table. The table 220b may be implemented as an assembly steps table. The table 220c may be implemented as a revision information table. The methods database 202a may be implemented having appropriate additional tables (e.g., tables 220(c+1)-220n) to meet the design criteria of a particular application. Each of the tables 220 is generally linked directly to the bus 206.

The images table 220a generally comprises one or more drawings, figures, images, etc. The image table 220a may be implemented as one or more files 230 (e.g., files 230a-230n). The files 230a may be implemented as one or more CAD files. The files 230b may be implemented as one or more multimedia files (e.g., animations, audio messages, etc.). The image table 220a may be implemented having one or more appropriate additional files (e.g., files 230(b+1)-230n) to meet the design criteria of a particular application. Each of the files 230 is generally linked directly to the table 220a.

The assembly steps table 220b generally comprises one or more main (major) assembly step (tables, directories, files, etc.) 240 (e.g., main assembly steps 240a-240n). Each of the main assembly steps 240 is generally directly linked (interfaced) to the assembly steps table 220b. Each of the main assembly steps 240 generally comprises one or more respective tables (directories, files, etc.) 250, 252, 254, 256, 258, 260 and/or 262 that may be directly linked to the respective table 240 and similarly implemented.

The table 250 may be implemented as a table containing information related to (corresponding to) the main assembly step 240 that is relevant to and/or maintained by a manufacturing engineer. The table 252 may be implemented as a table containing information relevant to and/or maintained by a line lead (shop floor supervisor). The table 254 may be implemented as a table containing information relevant to and/or maintained by a quality engineer.

The table 256 may be implemented as a routing stations table containing information related to (corresponding to) the main assembly step 240 codes and/or descriptions of the product (unit) that may be assembled at the respective workstation 204. The table 256 may also contain information related to the product that is currently being manufactured at a particular workstation 204. The table 256 may be relevant to and/or maintained by the manufacturing engineer and/or other appropriate employees.

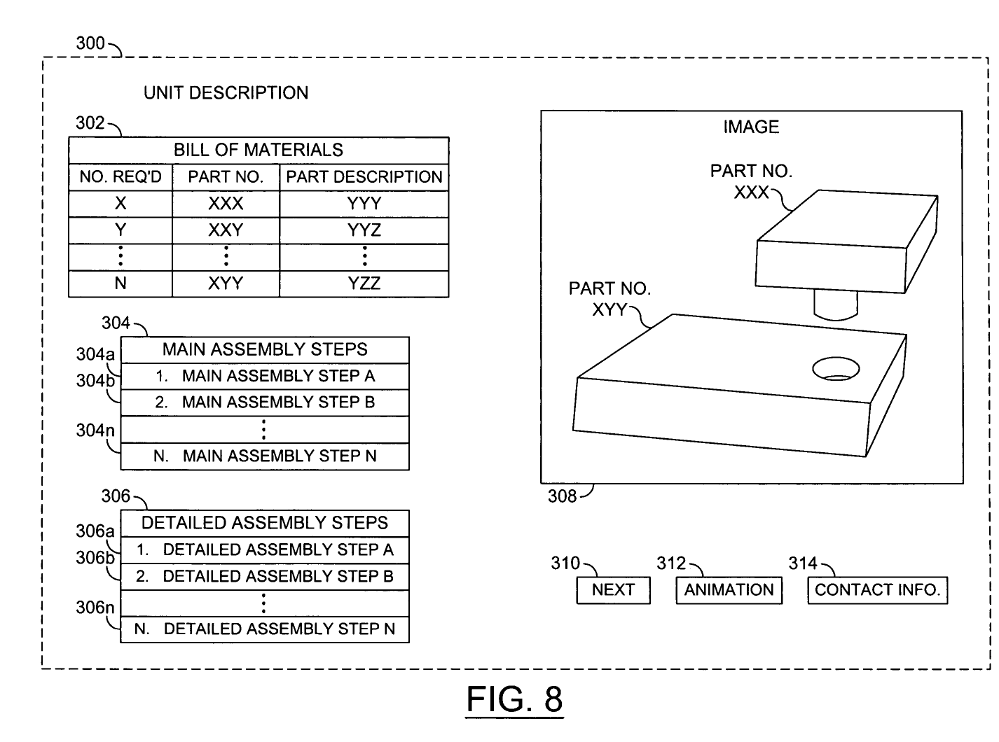

The table 258 may be implemented as an assembly detail steps (e.g., detailed assembly steps) table (described in connection with FIG. 8). The table 260 may be implemented as a job information table. The table 260 generally contains information related to one or more shop orders that correspond to the product being assembled at a particular workstation 204. The table 260 may be directly linked (coupled) to the manufacturing execution system database 202b through the bus 206.

The assembly steps 220 may be implemented having appropriate additional tables 262 that may contain additional information to meet the design criteria of a particular application.

Referring to FIG. 7a, a diagram illustrating the manufacturing execution system database 202b in accordance with a preferred embodiment of the present invention is shown. The database 202b generally comprises one or more tables (directories, files, etc.) 270 (e.g., tables 270a-270n). Each of the tables 270a-270n is generally linked (coupled) directly to the bus 206. Each of the tables 270 may be further configured as one or more appropriate files, directories, sub-tables, etc. to meet the design criteria of a particular application.

The table 270a may be implemented as a work in process (WIP) table. The table 270b may be implemented as an inventory control table. The table 270c may be implemented as a shop order information table. The table 270d may be implemented as a BOM table. The database 202b may be implemented having one or more appropriate additional tables (e.g., tables 270(d+1)-270n) to meet the design criteria of a particular application.

Referring back to FIG. 5, the operator generally performs the assembly steps 220 at a workstation 204 that comprises a computer system (not shown) coupled to the bus 206. The computer system generally comprises a number of user interface (e.g., communication) devices and/or media such as one or more display screens, keyboards, mice, touch screens, scanning devices, barcode readers and/or printers, foot pedals, hands-free devices such as speech recognition hardware and software, etc. However, the computer system may have any appropriate configuration (e.g., databases, linked databases, tables, linked tables, linked tables between databases, database interfaces, user interfaces, etc.) to meet the design criteria of a particular application.

The employee database and/or tables (not shown) may comprise information that corresponds to employee training, certification, access level (e.g., security), quality of units assembled by the employee, etc. However, the employee database may be implemented having any appropriate information to meet the design requirements of a particular application.

The system 100 generally provides a method and/or architecture such that a user (e.g., manufacturing engineer, mechanical engineer, technician, line lead, supervisor, operator, etc.) may view online one or more screens (e.g., lists) that correspond to the product and/or assembly related BOM, assembly steps (e.g., main assembly steps 240 and/or detailed assembly steps 258), components (e.g., parts, sub-assemblies, assemblies, systems, sub-systems, etc.), inter-relationships (e.g., animation of assembly sequence, relative positions of components, etc.), inventory, production status, level of revision (e.g., of component, of process, etc.), operator security and/or training levels, etc. Access to the screens (e.g., the corresponding databases 202 and/or respective tables where the information displayed on the screen is stored) is generally controlled to a predetermined level authorized for a particular user.

The method 100 generally comprises a step (or block) 102, a step (or block) 104, a step (or block) 106, and a step (or block) 108. During the step 102 the operator (or user) generally logs onto the direct methods system 100 via a computer-coded identification (e.g., the operator scans a badge via the workstation 204 computer system). The system 100 generally continues to the step 104.

During the step 104 the operator may scan a job number from job paperwork into the direct methods system 100. The process 100 is generally configured to retrieve an appropriate set of predetermined methods (e.g., assembly steps 240 and/or 258, drawings 23a, positions of relative components, assembly aids such as assembly sequence animation 230b, etc.) in response to the operator identification, the BOM (e.g., the BOM 270d), and/or the workstation 204 where the operator is logged in from the appropriate databases 202 where the information (data) is stored. In one example, the process 100 may be configured to communicate the appropriate set of methods (e.g., from the database 202a) to the user via displaying one or more screen images (e.g., images on a computer monitor). However, the process 100 may be configured to communicate the appropriate set of methods to the user via any appropriate interface to meet the design criteria of a particular application.

Referring to FIG. 8, a screen image 300 is shown in accordance with a preferred embodiment of the present invention. The screen image 300 is generally implemented by the process 100 viewer. The image 300 generally comprises a BOM 302, a list (description) of one or more predetermined major (e.g., main or A primary) assembly steps 304 (e.g., 304a-304n), a list (description) of one or more predetermined detailed assembly steps 306 (e.g., 306a-306n), an image (section, figure, picture, drawing, animation, etc.) 308, a NEXT button (or icon) 310, an ANIMATION button (or icon) 312, and a CONTACT button (or icon) 314. The BOM image 302 may interface with (e.g., be retrieved from, be linked to, share data with, be derived from, correspond to, etc.) the BOM 270d of the manufacturing database 202b. The BOM 302 may be more accurate than the conventional assembly process 10 BOM that is entered separately from the conventional manufacturing database BOM.

The list of major (main) assembly steps images 304a-304n generally corresponds to the assembly of sub-systems (e.g., groups of parts) into the completed assembly for a stage of manufacture that corresponds to the workstation. The major assembly step images 304 generally correspond to (are linked to, derived from, etc.) the methods database 202a main assembly steps 240. The list of detailed assembly steps 306a-306n generally corresponds to the assembly of components (e.g., parts, sub-systems, etc. listed in the BOM 302) into the appropriate sub-assemblies. The detailed assembly step images 306 generally correspond to (are linked to, derived from, etc.) the methods database 202a detailed assembly steps 258. In one example, the main assembly steps 304 may comprise one or more detailed assembly steps 306. However, the number and type of assembly steps 304 and/or 306 may be implemented to meet the design requirements of a particular application. The assembly steps 304 and 306 are generally numbered.

In one example, one or more of the steps 304 and/or 306 may be implemented as product related tests (e.g., performance, fit, continuity, etc.) that are to be successfully completed prior to the implementation of the succeeding step. The process 100 may be configured to prevent noncompliant products from having additional assembly steps performed until the noncompliance is remedied. However, the lists of the assembly steps 304 and/or 306 may be configured to indicate any appropriate assembly steps to meet the design criteria of a particular application. The process 100 is generally configured to prevent the unit from having subsequent assembly steps 304 and/or 306 started and/or performed until each prior assembly step is completed.

The image 308 generally displays an image (or view) of the product that corresponds to the particular workstation 204 and the assembly steps 304 and/or 306 that are to be performed at the workstations 204. In one example, the figure displayed in the image 308 may be implemented as a computer aided drawing (CAD) image that was generated during the design of the product (e.g., the system 100 may be configured to interface with a design drawing library database such as the table 230). In another example, the figure displayed in the image 308 may be implemented as a digital picture contained in the table 220. In another example, the image 308 may be implemented as a tagged image file format (TIFF) file display. However, the figure displayed in the image 308 may be 20 implemented as any appropriate image and/or format and stored in and retrieved from any appropriate database 202 and/or respective table to meet the design criteria of a particular application.

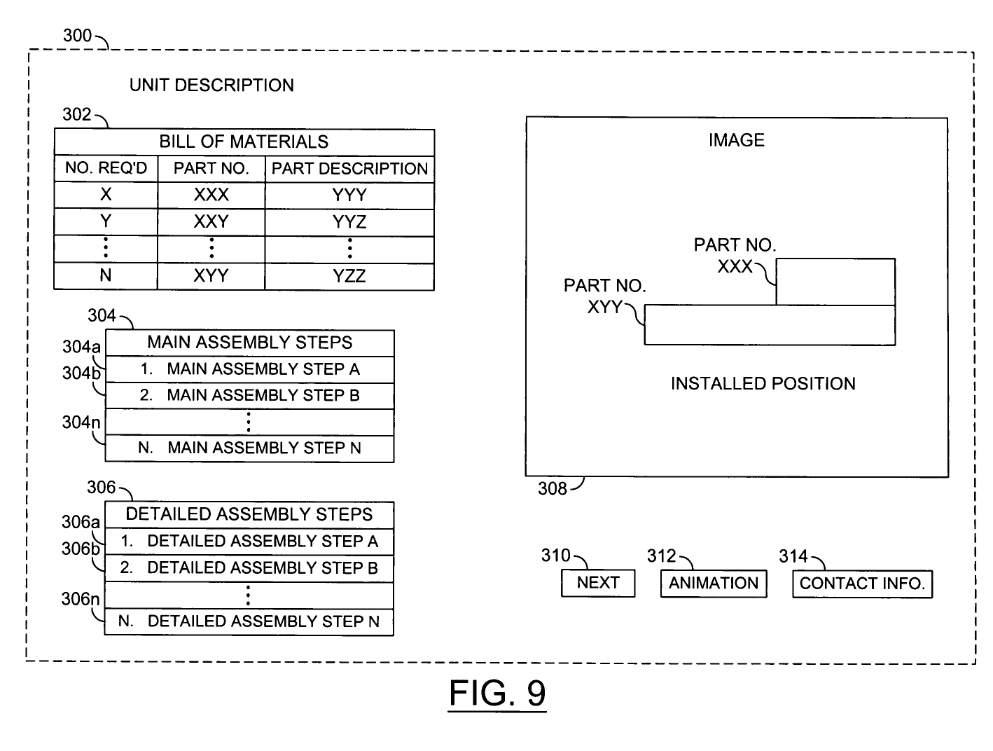

Referring to FIG. 9, an alternative view displayed as the image 308 is shown. The NEXT button 310 may be configured to sequence the system 100 (and the screen image 300) through successive major assembly steps 304 and/or detailed assembly steps 306. The image 308 shown in FIG. 9 may represent a view of the unit being assembled having components in an installed position. The system 100 is generally configured such that each of the steps 304 and/or 306 are successfully completely prior to the implementation and display of the succeeding step 304 and/or 306.

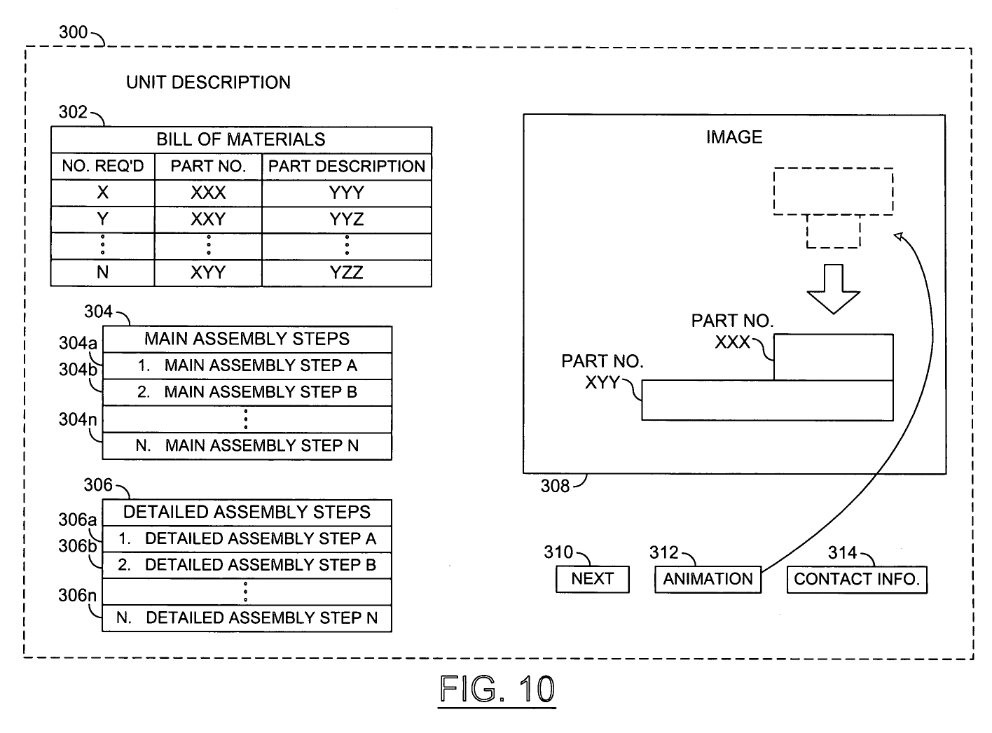

Referring to FIG. 10, an alternative view of the image 308 is shown. The ANIMATION button 312 may be configured to activate an animation sequence of the figure displayed in the image 308. In one example, the ANIMATION button 312 may activate a viewing sequence that illustrates a preferred assembly sequence of a number of parts (e.g., a sequence stored in the multimedia table 230b). In another example (not shown), the ANIMATION button 312 may activate a rotational viewing of the image 308 (e.g., to provide a three-dimensional view of the product). However, the ANIMATION icon 312 may be configured to activate any appropriate animation (or similar representation such as an audible description) to meet the design criteria of a particular application.

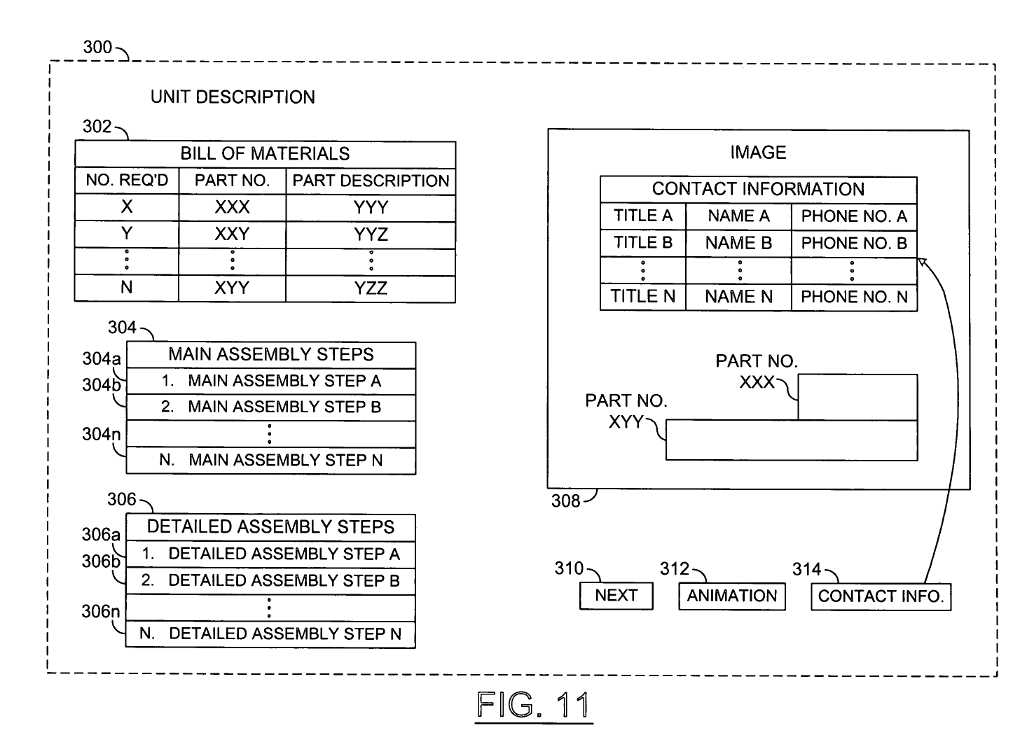

Referring to FIG. 11, an alternative view of the screen 300 is shown. The CONTACT button 314 may be configured to display a list of appropriate contact personnel (e.g., support personnel) and information that corresponds to contacting them (e.g., title, name, telephone number). The contact information that is displayed in response to activation of the icon 314 is generally stored in and retrieved from one or more of the linked databases 202 (e.g., the manufacturing database 202b, the employee database, etc.). The contact information may be displayed at any appropriate location on the screen 300.

Referring back to FIG. 5, the process 100 generally reads the BOM 302 (and/or 270d) that corresponds to the job from the appropriate database (e.g., the manufacturing database 202b). The system 100 generally displays the BOM image 302 on the screen for the operator to view. The process 100 generally continues to the step 106.

During the step 106 the operator generally completes assembly of the unit in response to the instructions on the screen 300 by performing the listed assembly steps images 304 and/or 306, viewing one or more figures in the image 308, and/or viewing animation via the ANIMATION button 312, if applicable. When each of the listed steps 304 and/or 306 is completed the operator may click (activate) the NEXT button 310 on the screen 300 to display (list) the next assembly step 304 and/or 306 description. The system 100 is generally configured to track the completion of each of the assembly steps 304 and/or 306. The system 100 may be configured such that the next assembly step 304 and/or 306 (e.g., 240 and/or 258) may not be started (e.g., accessed) and/or performed until each of the prior assembly steps 304 and/or 306 is completed. Inventory (e.g., one or more components) is generally consumed as each step 304 and/or 306 is completed. The system 100 is generally configured to track the consumption of the inventory (e.g., update the one or more inventory databases and/or tables such as the table 270b) while each step 304 and/or 306 (e.g., 240 and/or 258) is performed.

The operator generally steps through (performs) each main assembly step 304. When applicable, the operator generally steps through (performs) each detailed step 306 that corresponds to each main assembly step 304. For configuration specific data, the direct methods system 100 generally matches part numbers in the BOM 302 with information in tables (e.g., data in the manufacturing database 202b) to display the pertinent information (e.g., part description, warnings, special precautions, etc.) on the screen 300. The operator generally does not view the tables, only information needed for the configuration that is being assembled. The system 100 may reduce or eliminate operator decisions and thus reduce opportunities for human error.

When the operator has completed all of the steps 304 and/or 306, the process 100 generally continues to the step 108. During the step 108 the unit being assembled is generally sent to the next assembly station 204.

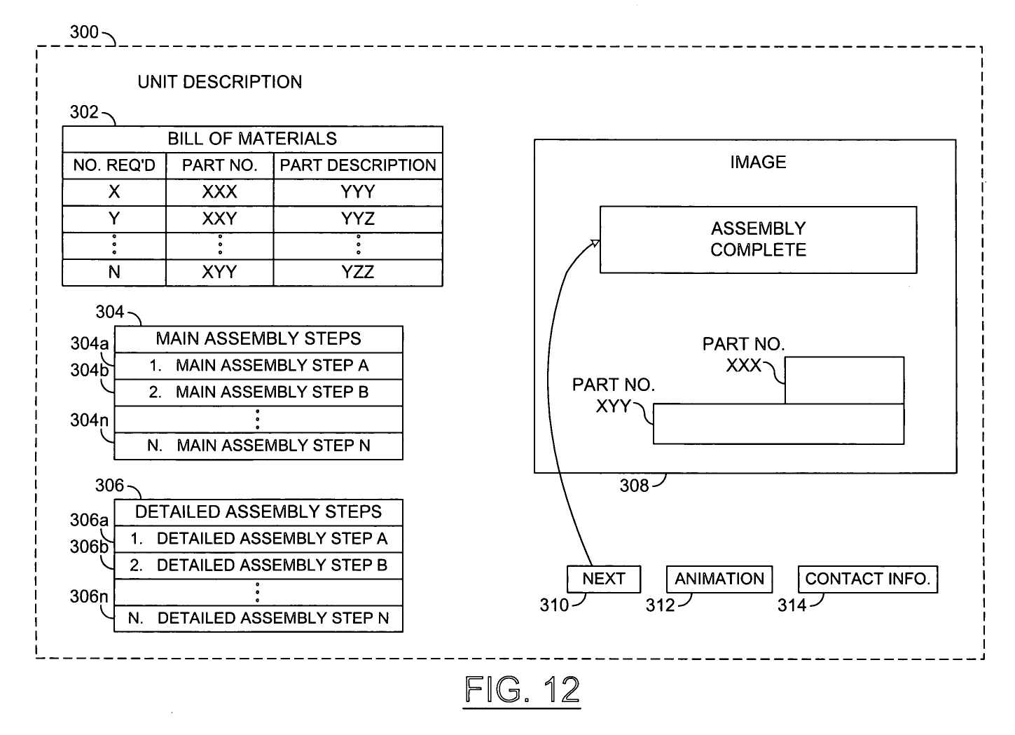

Referring to FIG. 12, another view of the screen 300 is shown. The screen 300 may display an image to the operator that the assembly steps 304 and/or 306 (240 and/or 258) have been completed for the unit being assembled in response to activation of the NEXT icon 310 and/or other appropriate system 100 interface action. The communication that the assembly is complete may displayed at any appropriate location on the screen 300 and/or by any other appropriate indicator (e.g., audible message).

The process 100 is generally implemented such that a certification may be a prerequisite to viewing the methods (e.g., successful user login at a particular workstation 204). Only trained (certified) operators may be authorized to access the assembly methods 304 and/or 306 and build the product. The process 100 may force the operators to view and complete every assembly step 304 and/or 306 in the direct assembly methods 100. The system 100 may be configured to link (correlate) the operators to the products assembled by the operators (e.g., by job part numbers, serial numbers, etc.) for tracking purposes (e.g., quality correlation) in connection with information (data) stored in the product quality databases. The system 100 may be configured to link the workstations 204 to the products assembled at the workstations 204 for tracking purposes in connection with information (data) stored in the product quality databases.

The system 100 may be configured to link the assembly methods (e.g., the steps 304 and/or 306) directly to inventory transactions (e.g., the one or more inventory databases and/or tables). Inventory (component) consumption tracked while the assembly methods steps 304 and/or 306 are performed may be implemented as a portion of a parts delivery system (e.g., Kanban, just-in-time, etc.). When the inventory at the workstation 204 reaches a predetermined level (e.g., a level determined by production scheduling, lean manufacturing modeling, etc.), the process 100 may be configured to notify a stock room (not shown) to replenish the workstation inventory. Similarly, when inventory at the stock room reaches a predetermined level (e.g., via a level determined by an economic order model, vendor delivery schedules, etc.), the process 100 may be configured to indicate (e.g., provide notice to buyers) that the stock room inventory may be replenished.

The present invention may implement the direct methods system 100 for product assembly that may provide easily developed and maintained assembly methods (e.g., the methods 304 (240) and/or 306 (258), the images 308, etc. communicated via the screen 300). The present invention may provide a complete product assembly information tracking and control system. The system 100 may be configured to directly display the list of appropriate methods (e.g., the methods 304 and/or 306, the images 308, etc.) at the appropriate time (e.g., at the corresponding workstation 204 and after all of the prior assembly steps have been completed). When the user (e.g., operator) scans the job number at the workstation 204 (e.g., during the step 104), the system 100 generally communicates the appropriate BOM 302 (270d), the list of assembly steps 304 and/or 306, and the image 308 from the corresponding databases 202 and/or respective tables to the user via the screen 300. The system 100 is generally configured to display the appropriate screen 300 in response to the completion of successive steps 304 and/or 306 and/or user interface actions (e.g., activation of the icons 310, 312, and/or 314).

The present invention may implement rich multimedia content to provide the operator an interactive experience. The process 100 may be configured such that the user may dynamically retrieve image and video content in real time in response to activation of the NEXT feature 310, the ANIMATION feature 312, and/or other interface actions. The process 100 may implement CAD animation, live video, etc. to provide visual assembly aid to the operator. In one example, the process 100 may be configured to provide the operator different views of the image 308 (e.g., portions and/or all of the image 308 may be enlarged/shrunk, a viewing angle may be changed, active rotation of the image may be displayed, etc.) in response to appropriate interface actions. In another example, the process 100 may be configured to display an animation of the preferred assembly procedure for the current assembly step 304 and/or 306.

The present invention may implement one or more application programming interfaces (API) such that drawing images, annotations, notes from drawings, etc. may be programmatically extracted (retrieved) from the corresponding databases (e.g., the database 202a) and/or tables (e.g., the tables 230) and displayed via the image 308 (e.g., during the step 104). In one example, the API may be implemented as Autodesk® Inventor™ API (trademarks of Autodesk, Inc. San Rafael, Calif.). In another example, the API may be implemented as Win32® (registered trademark of Microsoft Corporation, Redmond, Wash.) API. However, the API may be implemented as any appropriate API to meet the design criteria of a particular application.

The present invention may be configured to track and record parts consumed from inventory during the assembly process (e.g., during the step 106). The present invention may be configured to provide various levels of inventory control (e.g., workstation inventory, stock room inventory, warehouse inventory, distribution center inventory, etc.).

The present invention may be configured to support one or more engineering change order (ECO) process launches via a direct methods 100 approval process. The direct methods approval process of the present invention may provide security analogous to database program security. The direct methods approval process of the present invention may be implemented having a security clearance process such that a user having limited security clearance may perform a portion of the methods 100 and/or the ECO and another user having a different security clearance may approve and submit a completed version of the methods (e.g., the steps 304 and/or 306, the image 308, etc.) and/or the ECO. The direct methods approval process of the present invention may be configured to (i) generate a report that may detail the methods 304 and/or 306 related tables and/or files to be updated when the ECO is implemented, (ii) generate a “to do” list of changes, (iii) directly launch the applications (e.g., drawings, operator training, workstations, etc.) where the changes may be made, (iv) update and/or record superseded methods 304 and/or 306 revision level fields of the table 220c during the database 202a update portion of the ECO process, (v) record and store the superseded methods, and/or (vi) generate reports including workstation screen graphics (e.g., graphical user interfaces such as the icons 310-314, configuration tables, etc.).

The system 100 of the present invention may integrate well with manufacturing management information systems (MMIS), factory automation systems (FAS), Win32® (or other software) application programming interfaces (API), and/or product application deployment and solution display software runtime server components (e.g., Inventor™ Apprentice Runtime, produced by Autodesk, Inc., San Rafael, Calif.). The system 100 may be implemented as a runtime object. The system 100 may communicate with other design and manufacturing components (e.g., one or more databases, inventory management systems, quality control systems, etc.). The system 100 may provide an interface to system-dependent capabilities (e.g., operator training, ECO systems, etc.). The FAS implemented in connection with the system 100 may be configured to resolve links between the databases 202 and/or the respective tables.

The present invention may provide an editor (not shown) configured to provide rapid, real time generation and maintenance of the system 100. The system 100 may provide operator level implementations. The present invention may provide workstation graphics that may directly correspond to assembly steps, sub-assemblies, components, etc. (e.g., graphics implemented via a “what you see is what you get” (WYSIWYG) format from the perspective of the operator on the screen 300). The databases 202 and/or the respective tables of the system 100 may be common and/or linked. Data may be shared between one or more of the databases 202 that comprise the system 100. Updates (revisions, modifications) to the data (information) in one database 202a-202n (e.g., performed with the system 100 editor) may be simultaneously if updated in one or more other databases 202.

The present invention may provide a flexible manufacturing model. The present invention may provide one or more test databases 202d and/or one or more simulators (generally implemented in connection with the respective test database 202d) that provide for work (e.g., changes to the assembly steps 304 (240) and/or 306 (258), the image 308, etc.) to be performed and tested off-line and implemented to production at a scheduled (predetermined) time. The test database 202d generally mirrors (replicates) the corresponding normal mode of operation database 202a-202n. The test database and/or the simulator 202d of the present invention may be implemented for training and/or other situations where the methods (e.g., the assembly steps 304 and/or 306, the images 308, etc.) may be viewed offline.

The present invention may correlate the operator and/or the assembly workstation to specific product data. The present invention may link specific operators (e.g., via the user login) to specific products (e.g., via serial numbers, product numbers, lot numbers, etc.) and product quality data (e.g., via the quality databases). The present invention may provide a direct link between assembly errors (e.g., assembly errors identified from it. product quality data) and the operator committing the errors. The present invention may indicate the operators that may be considered for additional training and/or the type of training to be provided in response to the product quality data.

The present invention may link (correlate) workstations 204 to specific products and product quality data. The present invention may indicate a workstation 204 (e.g., via assembly steps 304 and/or 306) that may be considered for reconfiguration and/or repair and the type of repair to be implemented in response to the product quality data.

The process 100 of the present invention may provide rapid implementation of new product designs, design updates, and/or manufacturing process updates. The present invention may provide manufacturing engineers more time to focus on engineering tasks and process improvements. The present invention may implement programmatic methods generation that may be applied to other assembly methods and/or projects in addition to assembly methods (e.g., the present invention may be scalable to other projects). The system 100 may enhance design and/or manufacturing engineering processes and/or support quality, design process, and/or production time improvement initiatives.

The present invention may implement an assembly methods development, maintenance and displaying format that may maximize velocity (e.g., reduce time) and improve quality of development and assembly of products and simultaneously minimize the resources implemented to perform the development and assembly of the products. The present invention may be compatible with and/or complementary to MMIS and/or FAS implementations. In one example, the process 100 may be compatible with the FAS Wonderware® (trademark of Wonderware Corporation, Lake Forest, Calif.). However, the process 100 may be compatible with any appropriate MMIS and/or FAS to meet the design criteria of a particular application.

The present invention may provide manufacturing engineers and technicians a method and/or architecture for developing and maintaining product assembly methods easily, rapidly and reliably. The present invention may provide a method and/or architecture for (i) reporting part number changes, (ii) revision control of system (e.g., drawings 220a, assembly steps 240 and/or 258, etc.) updates and archival of prior implementations (e.g., the tables 220c), and/or (iii) verifying changes prior to implementing the changes via the one or more simulators and/or test databases (e.g., the test database and/or simulator 202d) that are configured to mirror the manufacturing databases 202a and/or 202b and/or other normal mode of operation databases 202.

The present invention may provide quality engineers improved process control. Since the process 100 generally accesses the assembly steps 304 and/or 306 in a step-by-step fashion (e.g., the next assembly step is not started and/or performed until each of the prior assembly steps are completed), the operator is generally unable to skip assembly steps and potentially degrade unit quality. The process 100 generally provides operator documentation. The system 100 may be coupled with a FAS (or MMIS). The operator (and/or workstation 204) may be linked to a particular unit via part number and/or serial number.

The present invention may be configured to provide quality engineers notification of changes, warnings, precautions, etc. The present invention generally provides revision control and system archival (e.g., through the table 220c). Since the system 100 generally provides linked databases 202 (e.g., the databases related to manufacturing, product design, employee certification, drawings, etc. are generally linked through the bus 206), the system 100 may be configured to ensure that the appropriate BOM 302 (270d), assembly steps 304 (240) and/or 306 (258), screen image 308, etc. are communicated to the appropriate workstations 204a-204n.

The direct methods of the present invention may provide the operators (i) clear, concise assembly instructions (e.g., the assembly step images 304 and/or 306, the images 308, the option of animation via the icon 312, etc.), (ii) a standard interface at each computer terminal/workstation 204 (e.g., the screen 300), and/or (iii) the appropriate BOM 302, assembly steps 304 and/or 306, screen image 308, etc. at the appropriate workstation 204.

The present invention may be implemented as a low maintenance and/or low technical support solution (e.g., the system 100). The low maintenance solution provided by the process 100 may be especially beneficial to an automation engineering group.

The present invention may provide a mirrored database and/or simulator 202d that may provide a training group an off-line environment for training the assembly operators. The present invention may be configured to train operators off-line on the method (e.g., the process 100 and/or the steps 304 and/or 306) implemented at the workstations 204. The process 100 may be configured to link specific product quality (e.g., via serial number, product number, lot number, etc. and the corresponding quality information) to specific operators (e.g., via the user login) and indicate the operators to consider for training and the type of training to be conducted.

The present invention may provide an expanded level of functionality (e.g., linked databases 202, inventory control, workstation 204 access control, etc.) and information (e.g., operator and/or workstation 204 to product quality correlation, inventory tracking in response to assembly steps, etc.) than conventional manufacturing methods. The present invention may support quality and velocity (e.g., rapid product and/or process development) initiatives.

In one example, the present invention may be implemented independently of the ECO process. The process 100 may be configured to generate one or more reports that may identify all applicable databases 202, respective tables, and/or files that are affected by changes to be implemented. Prior to the ECO implementation, the user may change one or more CAD models (e.g., database 202a, tables 230a, files such as Autodesk® Inventor™ files having a format that corresponds to an extension or suffix .iam) via an administration process (operation, routine, instruction set, etc.). The user may update model files (e.g., the .iam extension files). The process 100 may be configured to update Autodesk® Inventor™ files (i) presentation files (e.g., database 202a files having a format that corresponds to an extension or suffix .ipn, not shown) and/or (ii) drawing files (e.g., database 202a files having a format that corresponds to an extension or suffix .idw, not shown). The model files, presentation files, and/or drawing files may be stored in one or more manufacturing, product drawing, and/or Autodesk® Inventor™ database 202a libraries, tables, directories, etc. However, the model files, presentation files, and/or drawing files may be stored in any appropriate media, tables, and/or databases to meet the design criteria of a particular application. The system 100 may be configured to interface with (access) (e.g., write to and/or read from) a number of the databases 202 (tables, libraries) simultaneously.

The present invention may implement an editor process (method, instruction set, routine, etc., not shown). The editor process of the system 100 may be configured to perform similarly to the normal operation modes of the system 100. The editor may be configured to generate a report that indicates the assembly steps 304 and/or 306, images 308, etc. that may correspond to the model, presentation, and/or drawing changes. The user may update (e.g., revise, modify, etc.) the process 100. The user may update the assembly steps 304 and/or 306 and the corresponding images 308, animations displayed in response to activation of the icon 312, contact information that corresponds to the icon 314, precautions displayed via the assembly step images 304 and/or 306 or the image 308, etc.

The editor may interface with the mirrored database (e.g., the one or more databases 202d that are configured similarly to the databases 202a-202n implemented by the process 100 during one or more normal modes of operation). The editor may be configured to generate one or more “where used” reports that indicate the assembly steps 304 and/or 306, images 308, workstations 204, etc. that may be affected by the updates to the process 100. New and/or revised major (main) steps 304, detailed steps 306, warnings, precautions, etc. may be entered via the editor. Drawings (e.g., images 308) that correspond to assembly steps 304 and/or 306 may be linked (e.g., attached) to each respective assembly step 304 and/or 306.

The system 100 may configure the mirrored (e.g., test, prototype, etc.) database 202d such that the user may verify the new and/or updated assembly steps 304 (240) and/or 306 (258), etc. The process 100 may be configured to generate one or more reports that indicate the updates. The report may be provided to appropriate personnel for review, communication, and/or comment on the updates. The report may be communicated via email, hardcopy, and/or any other appropriate media. The updates are generally approved and signed off.

The updates may be posted (e.g., communicated to the appropriate personnel, implemented at the appropriate workstations 204, etc.) at one or more predetermined dates and times. The dates and times for posting may be determined in response to production schedules, inventory quantities, training schedules, etc. In one example, the updates may correspond to database 202 revisions. In another example, the updates may correspond to product serial numbers. However, the updates may be implemented according to any appropriate criteria to meet the design criteria of the particular application. The present invention is generally configured to archive all superseded assembly steps 304 and/or 306, drawings 220a, etc.

The process 100 editor may be configured to operate similarly to the process 100 viewer (e.g., one or more normal modes of operation). The editor may be implemented such that any of the fields in the databases 202 may be updated. The editor may be configured to provide updates to the assembly steps 304 and/or 306, the images 308, precautions, drawings, animations, etc. The editor may be configured to support the WYSIWYG format of the normal operation modes of the system 100. The editor may be configured to register all content on the screen 200 to one or more database 202 tables and/or files. In one example, the databases 202 may be implemented as structured query language (SQL) server databases. However, the databases 202 may be implemented as any appropriate databases to meet the design criteria of a particular application.

The present invention may be configured to provide one or more “where used” reports. The reports may indicate one or more methods (e.g., assembly steps 304 and/or 306) that may be updated in response to other updates (e.g., part number updates, drawing updates, etc.) that are performed. The reports may indicate information to be updated in the assembly steps 304 and/or 306. The process 100 reports may also indicate drawings (e.g., files having the extension .idw) that may be updated in response to other updates. In one example, the present invention may provide a graphical user interface (GUI) to directly launch the drawings (e.g., the .idw files for updating). In another example, a product document management (PDM) program may be configured to directly update the appropriate drawings. The report generated during an operation of the process 100 editor may be integrated with the direct methods 100 viewer process.

The process 100 may be configured to verify new and/or updated methods (e.g., the assembly steps 304 and/or 306, images 308, etc.) via the test database 202d in connection with the sign off procedure. The process 100 may implement one or more batch jobs configured to refresh (update) one or more production (e.g., normal mode of operation) databases 202 with the new and/or updated information. The process 100 may be configured to generate the images 208 directly from the drawing database tables and/or files 220a via an API.

When the process 100 is implemented in connection with the ECO process, updates may be scheduled in connection with ECO date and time breaks. The present invention may be configured to generate one or more reports that list superseded methods (e.g., the updated main steps 304 and/or detailed steps 306, images 308, etc.).

The system 100 may implement workstation 204 graphics (“screen shots”) that may directly correspond to operations, sub-assemblies, components, preferred assembly sequences, etc. from the perspective of the operator (e.g., in the WYSIWYG format). The system 100 may be compliant to one or more International Standards Organization (ISO) 9000 series standards.

The process 100 may be configured to track inventory that may be consumed while the operator performs major steps 304 and/or detailed steps 306. The present invention may provide linking (interfacing) of the assembly steps 304 and/or 306 to inventory levels through the inventory control table 270b. The method 100 may provide a framework for inventory replenishment at the workstation 204, store room, distribution center, etc. The process 100 may be tightly integrated with an FAS such as Wonderware® or an MMIS. The system 100 may be implemented to support rapid product design and/or manufacturing process initiatives.

The present invention may provide for classification (certification) of the assembly operator into levels of experience and/or training for given assembly steps (e.g., the assembly steps 304 (240) and/or 306 (258)) and/or workstations 204. For example, an operator classified within a first tier (e.g., an inexperienced operator) may be authorized (certified) to proceed to each next step 304 and/or 306 after scanning a product number and/or serial number that corresponds to the unit being assembled. Activation of the NEXT icon 310 may be performed via clicking a cursor on the screen 300 image, touch screen activation, foot pedal activation, etc. An operator classified in another (e.g., advanced, experienced) tier may perform timed operations (e.g., auto play, pause, etc.) and/or activate only main step images 304. However, the system 100 generally tracks all inventory that is consumed during the assembly of the unit regardless of the operator classification.

The present invention may provide seamless integration with a FAS (or a MMIS) from initial product and/or process development stages. The present invention may implement the direct methods process 100 and the FAS during the modeling stage of product and/or process development. The integrated direct methods process 100 and FAS (or MMIS) may be designed and developed concurrently as a single solution for factory floor implementation. The direct methods process 100 and the FAS may implement a common language and architecture that may provide ease of development and maintainability. The process 100 and the FAS may implement shared data (e.g., one or more common and/or linked databases 202). In one example, common and/or linked databases 202 may be implemented for tracking component (inventory) consumption in connection with the assembly steps 304 and/or 306 (e.g., common and/or linked bill of materials tables 270d and/or inventory control tables 270b). In another example, common and/or linked databases 202 and/or tables may be implemented to correlate a current unit being assembled and the workstations 204. However, the present invention may be implemented having any number and configuration of common and/or and simulators 202d may provide users (e.g., engineers, designers, etc.) a method and/or architecture to try out new changes before commitment to production systems. The test database and simulator 202d may be configured such that the present invention is compliant to one or more of the ISO 9000 series of standards. The ISO 9000 compliant system 100 may provide users maximum usability and acceptance.

The process 100 and the FAS may be written as a single interface. The single interface of the present invention may provide lower costs. The single interface of the process 100 may share resources (e.g., databases 202 linked through the bus 206) and reduce or eliminate redundant interface programming. In one example, 60% or more of common data and/or programming may be integrated into the single interface solution of the present invention. The single interface of the present invention may reduce or eliminate errors introduced when programming is rewritten to accommodate multiple interfaces.

The present invention may be faster and more efficient than a conventional system such as the system 10. The system 100 may provide more control than conventional systems. The process 100 may interactively track component (e.g., inventory, material)

The present invention may be faster and more efficient than a conventional system such as the system 10. The system 100 may provide more control than conventional systems. The process 100 may interactively track component (e.g., inventory, material) consumption (e.g., the assembly steps 304 and/or 306 may be linked to the inventory control tables 270b). The process 100 may interactively track product quality. The process 100 users (e.g., the operators and/or workstations 204) may be linked (tethered) to methods (e.g., the assembly steps 304 and/or 306).

The present invention may provide product design integration (e.g., integration with software such as Autodesk® Inventors™). In one example, picture files 308 may be generated from drawing sheets. In another example, the image 308 may be implemented as a digital picture. However, the image 308 may be implemented as any appropriate format to meet the design criteria of a particular application. The drawings that correspond to the image 308 may be implemented with a format that comprises one or more of a title block, annotations, inventor notes, precautions, etc. The system 100 (e.g., the image 308) may be configured to support drawings for a variety of sheet sizes, types of view (e.g., front, plan, etc.), wireframe, shaded, isometric, realistic (e.g., perspective), and/or enlarged/exaggerated/shrunk to emphasize particular details. A drawing template implemented in the process 100 may be generated in any appropriate format to meet the design requirements of a particular application. The present invention may implement the animation activated in response to the icon 312 with any appropriate format (e.g., video streaming).

The present invention may provide standard for the exchange of product data (STEP) (e.g., ISO 10303) compliant file translation. The STEP files generated during the process 100 may be especially beneficial to manufacturing engineering groups. The STEP files may be available on one or more of the manufacturing databases (e.g., the database 202b). The present invention may support a rapid and efficient design review process.

The shared and integrated databases 202 of the present invention may provide improved quality. For example, clearance dimensions may be reviewed by quality engineering and operations management as the product design drawings are developed without coordination through other engineering groups. The present invention may reduce or eliminate redundant drawings. Drawings for accurate fabrication of assembly fixtures may be developed concurrently (simultaneously) in connection with the product design drawings. The system 100 may provide a method of generating and updating drawing views in less time than conventional methods. A standard template may be implemented. Parts changes may be dynamically updated (e.g., via the process 100 editor).

In one example, the process 100 may be implemented in connection with a FAS (or MMIS). In another example, the process 100 may be implemented independently of a FAS (or MMIS). The present invention may be implemented as a turnkey system. The system 100 may provide cost savings when compared to conventional systems. The present invention may reduce the time to produce and maintain assembly methods, drawings, etc. The present invention may provide an improved opportunity cost scenario.

The present invention generally supports a proactive role for all personnel (e.g., assembly operators, quality, training, manufacturing engineering, design engineering, inventory control, etc.). The present invention may implement direct manufacturing assembly methods (e.g., the assembly steps 304 and/or 306). The present invention may support flexible manufacturing models. The process 100 may be configured to display the appropriate methods (e.g., assembly steps 304 and/or 306, image 308, etc.) for each job. The present invention may be implemented in a standard format that may provide more flexible operations.

The present invention may provide the operators with a reduced learning curve. The operators may be trained via the test (mirrored) database and/or simulator 202d of the process 100. The present invention may support quality and velocity (e.g., rapid product and/or process development and update) initiatives. The system 100 may be configured to incorporate user (e.g., engineer, operator, training personnel, operations personnel, etc.) feedback for “tweaking and fine-tuning.” The cost and time savings generated by implementation of the system 100 may justify implementation of the system 100 in a wide variety of applications.

While the system 100 has been generally described in connection with an example that is implemented having the viewing screen 300, in another example the system 100 may be implemented having auditory and/or tactile (e.g., foot pedal) user interfaces such that vision impaired and/or hands-free users may fully function the system 100. However, the system 100 may be implemented having any appropriate user interface to meet the design requirements of a particular application.

As used herein, the term “simultaneously” is meant to describe events that share some common time period but the term is not meant to be limited to events that begin at the same point in time, end at the same point in time, or have the same duration.

The function performed by the method (process, operation, etc.) 100 of FIG. 5 may be implemented using a conventional general purpose digital computer programmed according to the teachings of the present specification, as will be apparent to those skilled in the relevant art(s). Appropriate software coding can readily be prepared by skilled programmers based on the teachings of the present disclosure, as will also be apparent to those skilled in the relevant art(s).

The present invention thus may also include a computer product which may be a storage medium including instructions which can be used to program a computer to perform a process in accordance with the present invention. The storage medium can include, but is not limited to, any type of disk including floppy disk, optical disk, CD-ROM, and magneto-optical disks, ROMS, RAMs, EPROMS, EEPROMS, flash memory, magnetic or optical cards, or any type of media suitable for storing electronic instructions.

While the invention has been particularly shown and described with reference to the preferred embodiments thereof, it will be understood by those skilled in the art that various changes in form and details may be made without departing from the spirit and scope of the invention.

1. A method for product assembly control comprising the steps of:
(A) presenting visual instructions to an operator for assembling said product using a plurality of assembly steps in response to (i) one or more internal procedures, (ii) one or more product specifications and (iii) one or more inventory components, wherein said visual instructions are presented without receiving decisions from said operator;
(B) tracking completion of said assembly steps, wherein said visual instruction for a next one of said assembly steps is not presented until each prior one of said assembly steps is completed; and
(C) tracking components consumed while performing said assembly steps.

2. The method according to claim 1, wherein step (A) further comprises storing an assembly step list in one or more linked databases each comprising one or more linked tables.

3. The method according to claim 2, wherein (i) step (A) further comprises displaying one or more images that correspond to said assembly steps and a bill of materials (BOM) that corresponds to said product to said operator and (ii) said images and said BOM are stored in said one or more linked databases.

4. The method according to claim 1, wherein said one or more assembly steps comprise one or more major steps and one or more detailed steps.

5. The method according to claim 2, wherein step (A) further comprises displaying contact information that corresponds to said assembly steps to said operator.

6. The method according to claim 2, wherein step (A) further comprises providing said operator access to said assembly step list in response to a certification.

7. The method according to claim 3, wherein step (A) further comprises animating said one or more of said images and said animating comprises a preferred assembly sequence.

8. The method according to claim 2, wherein step (A) further comprises linking product quality data to said operator and training said operator in response to said product quality data.

9. The method according to claim 1, wherein step (A) further comprises linking product quality data to a workstation where said assembling is performed and repairing said workstation in response to said product quality data.

10. The method according to claim 1, wherein step (C) further comprises linking said component consumption to one or more inventory tables and replenishing workstation components in response to said part consumption.

11. The method according to claim 1, wherein step (A) further comprises updating said one or more assembly steps in response to one or more engineering change orders.

12. The method according to claim 11, wherein step (A) further comprises implementing said engineering change orders with one or more simulators and one or more test databases that are configured to mirror one or more normal mode of operation databases.

13. The method according to claim 1, wherein said method further comprises integrating steps (B) and (C) with a factory automation system (FAS).

14. A computer readable medium containing one or more sets of computer executable instructions for performing the steps of claim 1.

15. A system for product assembly control comprising:
means for presenting visual instructions to an operator for assembling said product using one or more assembly steps in response to (i) one or more internal procedures, (ii) one or more product specifications and (iii) one or more inventory components, wherein said visual instructions are presented without decisions from said operator;
means for tracking completion of said assembly steps, wherein said visual instruction for a next one of said assembly steps is not presented until each prior one of said assembly steps is completed; and
means for tracking components consumed while performing said assembly steps.

16. A method for controlling product quality comprising the steps of:
(A) presenting visual instructions to an operator for assembling said product using a plurality of assembly steps in response to (i) one or more internal procedures, (ii) one or more product specifications and (iii) one or more inventory components, wherein said visual instructions are presented without decisions from said operator; and
(B) linking one or more operators performing said assembly steps to said product quality via one or more linked databases, wherein said linked databases each comprise one or more linked tables.

17. The method according to claim 16, wherein step (B) further comprises providing said one or more operators access to said assembly steps in response to a certification.

18. The method according to claim 16, wherein step (B) further comprises training said one or more operators in response to said product quality.

19. The method according to claim 16, wherein said method further comprises the steps of:
linking one or more workstations where said assembly steps are performed to said product quality via said one or more linked databases; and
repairing said workstation in response to said product quality.

20. A computer readable medium containing one or more sets of computer executable instructions for performing the steps of claim 16.
